(19) United States
(12) Patent Application Publication
(10) Pub. No.: US 2011/0078055 A1
(43) Pub. Date: Mar. 31, 2011

(54) METHODS AND SYSTEMS FOR FACILITATING SELECTING AND/OR PURCHASING OF ITEMS

(76) Inventors: Claude FARIBAULT, Montreal (CA); Gregory Saumier-Finch, Outremont (CA); Jean-Francois St-Arnaud, Montreal (CA); Louise Guay, Outremont (CA); Elizabeth Haydock, Montreal (CA)

(21) Appl. No.: 12/769,499

(22) Filed: Apr. 28, 2010

Related U.S. Application Data
(63) Continuation of application No. 12/585,143, filed on Sep. 4, 2009, now abandoned.
(60) Provisional application No. 61/094,812, filed on Sep. 5, 2008.

(51) Int. Cl. G06Q 30/00

(52) U.S. Cl. 705/27.2

(57) ABSTRACT

Methods and systems for facilitating the selecting and/or the purchasing of items are provided. Items to be purchased may be clothing items. The use of a visualization pane comprising an avatar may be used to facilitate item selection. The avatar may represent a person such as a user and clothing items may be represented on the avatar so as to provide a preview of how the clothing items would look on the user. Searching for purchasable items may be done textually or visually using key images or by a combination of both. Key images selected from a dictionary of key images may to represent search criteria. Coupon offers may be presented to a user which may be redeemable instantly or later at a store location.

### CROSS-REFERENCE TO RELATED APPLICATIONS

The present application claims the benefit under 35 U.S.C. §120, as a continuation of U.S. non-provisional patent application Ser. No. 12/585,143, filed on Sep. 4, 2009 entitled “METHODS AND SYSTEMS FOR FACILITATING SELECTING AND/OR PURCHASING OF ITEMS” by Claude FARIBAULT et al, hereby incorporated by reference herein, which in turn claims the benefit under 35 U.S.C. §119(e) of U.S. Provisional Application Ser. No. 61/094,812, filed on Sep. 5, 2008 by Claude FARIBAULT et al.

### FIELD OF THE INVENTION

The present invention relates to the field of visual systems and more specifically graphical user interfaces. The present invention relates to the field of searches and more specifically to visually assisted search. The present invention also relates to graphical purchasing systems as well as to in-store purchasing aids. The present invention also relates to promotional system and more specifically to personalized promotion system.

### BACKGROUND OF THE INVENTION

In the physical shopping experience, a user needs to go to store and use up their time, money, gas, etc. to discover whether the object they're looking for is in the store they want to visit. If object is there, the user must spend more time evaluating the object, such as by trying on a piece of clothing, which can be inefficient. This can be problematic given the lack of easy way of finding out whether a given store has a given object beforehand and additional time may be needed to model the object.

Once in a store an find and evaluating objects of interest (such as by trying on clothing) may be difficult due to space constraints, limits on the amount that can be brought into a changing room and because of constrains on trying out the items. For example, trying on clothes takes time and not every item can be tried on. Likewise furniture may not be adequately tried without seeing the way the furniture fits in and matches with the room it is to be used in. This can be problematic because the inherent delays between discovery and evaluation can be so great that a user may simply give up and walk out, resulting in a loss of the sale.

to In an online shopping experience, a user may only have a vague idea of what they're looking for (e.g. men's dress shirts). This can be problematic because a text search (e.g. via third party search engines such as web browsers and store search engines) can return an overwhelming amount of results; without providing a structured way of narrowing in on what the user wants (e.g. a pea-green dress shirt that's 16½×32/33 with French cuffs and an Oxford collar that's pleated in the back).

Furthermore, current online shopping sectors offer non-engaging experiences and lack the fun and excitement of traditional store-based shopping. Many online stores use text-base searching systems which can be difficult for a user to employ when the user knows what they are looking for but do not know how to express their ideas textually. This is a particular nuisance when searching for clothing or furniture where the nomenclature tends to be complex.

When an online browser does find the object they're looking for, they may have no way of determining whether it is right for them, such as whether it fits their body type (if clothing) or kitchen/home decor (if appliance) or whether it would look good in the intended environment. Furthermore, in the case of clothing, a user currently has no way of knowing which size fits best when shopping online This can be problematic because most online retailers will accept returns but may not be responsible for return shipping costs and may charge “restocking fees” for big ticket items, such as TVs or other electronics

Retailers want cost effective user-centric web3D tools but fear destabilizing their site. Furthermore, the web3D tools currently in existence do not allow for seamless purchasing without being taken out of the environment and causing an unpleasant disconnect for the user.

Retailers have been struggling to offer discounts and savings coupons to its customers for use in-stores or online, only to find them posted on a variety of internet sites for mass distribution and abuse. Such unauthorized and unwanted usage of these coupons effectively devalues the campaigns or initiatives originally intended to increase KPI' s, discourages retailers from continuing to offer such incentives and most importantly, blurs the data on the actual impact and results of such campaigns or initiatives.

In the context of the above, it can be appreciated that there is a need in the industry for an improved visual system.

### BRIEF DESCRIPTION OF THE DRAWINGS

A detailed description of examples of implementation of the present invention is provided hereinbelow with reference to the following drawings, in which:

FIG. 1 shows an apparatus for implementing a user interface according to a non-limiting embodiment;

FIG. 2 shows a network-based client-server system 200 for displaying a user interface for the system;

FIG. 3 shows an implementation of a GUI in accordance with a non-limiting embodiment;

FIG. 4 shows a flowchart showing the general steps followed by a user purchasing goods;

FIG. 5 shows a flowchart showing the general steps followed by a user purchasing goods;

FIG. 6 shows a non-limiting example of a key image search display;

FIG. 7 shows a non-limiting example of a combined key image and text search display;

FIG. 8 shows a non-limiting example of a coupon alert in the graphical user interface; and to FIG. 9 shows a non-limiting example of some customization tools from the customization toolset.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

According to a non-limiting definition, the term “virtual representation” may refer to a digital description of any object, item or environment that can be represented visually via a computing device. As used here, virtual simulations refer to digital models of real-world objects (such as human bodies and clothing or household environments and appliances) that can be represented in two- or three-dimensions (2D or 3D, respectively) and rendered by a computing device to be seen by a human user.

to A user may refer to a living human being who uses the system in order to achieve a given result, such to identify, evaluate and purchase an object or item that is represented by a virtual simulation in the system. Typical users may include those searching for goods that fall within the following broad categories:
clothing, such as shirts, skirts, blouses, and suits;
fashion accessories, such as shoes or handbags;
household appliances, such as dishwashers and refrigerators;
home electronics, such as televisions and home stereos;
furniture, such as sofas and dining room sets;
vehicles, such as cars or trucks; and/or
household storage systems, such as kitchen cabinets.

The users and the items presented here constitute a non-exhaustive list as other possibilities remain and fall within the scope of the present invention.

An organization may refer to an entity that implements and maintains the system for.

Such organizations may include private businesses and governmental agencies, and may also include public organizations such as charities and non-governmental organizations. The system may be used throughout the organization or in one part of the organization, such as in a division or department and may be made available to the general public. Since the typical organization that uses the system includes businesses, the term organization, business and company are synonymous, except where noted otherwise.

An “avatar” refers to an virtual representation, specifically one that represents the body of a user of the system. In the context of the methods and systems described here, an avatar is assumed to visually represent a human body, and more specifically visually represent the current (or envisioned future) form of its user in terms of physical characteristics. Physical characteristics that could be modelled include, among others:
skin color;
overall body shape (such as “pear” or “apple” shaped bodies);
hair style and color;
eye shape and color;
waist size;
bust/chest size; and/or
nose shape.

It should be understood that the physical characteristics identified above constitute entries in a non-exhaustive list as other characteristics exist and would fall within the scope of the invention.

Those skilled in the art should appreciate that in some embodiments of the invention, all or part of the functionality previously described herein with respect to the system may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared, RF or other transmission schemes).

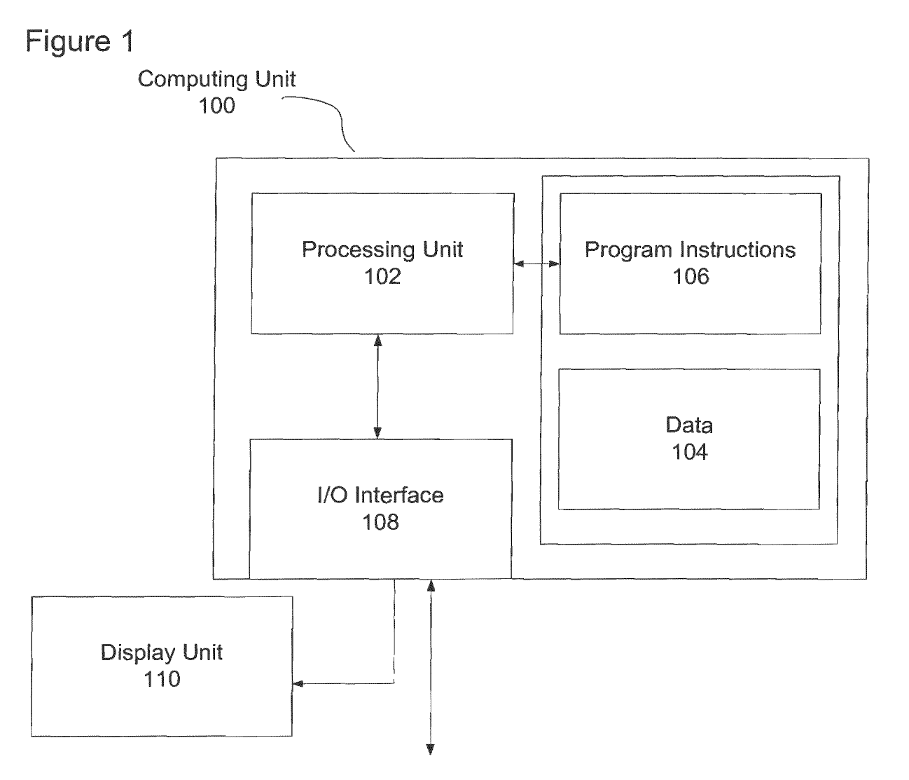

The apparatus for implementing a user interface according to a non-limiting embodiment may be configured as a computing unit 100 of the type depicted in FIG. 1, including a processing unit 102, data 104 and program instructions 106. The processing unit 102 is adapted to process the data 104 and the program instructions 106 in order to implement the functional blocks described in the specification and depicted in the drawings. The computing unit 100 may also include an I/O interface 108 for receiving or sending data elements to external devices. For example, the I/O interface 108 is used for receiving a control signals and/or information from the user, as well as for releasing a signal causing a display unit 110 to display the user interface generated by the program instructions 106. Optionally, the computing unit 100 may include additional interfaces (not shown) for receiving information from additional devices such as a keyboard or pointing device attached to the unit for example. The computing unit shown in FIG. 1 may be part of any suitable computing device including, but not limited to, a desktop/laptop computing device or a portable digital assistant device (PDA), or smartphone (such as a Blackberry™)

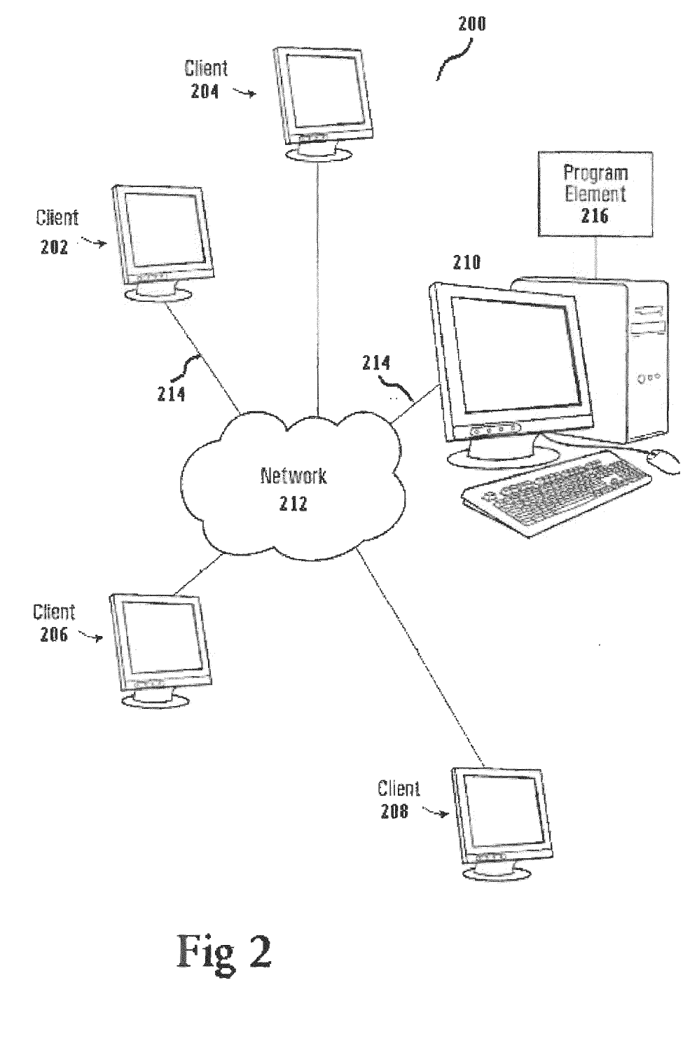

It will be appreciated that the system may also be of a distributed nature whereby a certain aspects may be prepared at one location by a suitable computing unit and transmitted over a network to a server unit implementing the graphical user interface (GUI). FIG. 2 illustrates a network-based client-server system 200 for displaying a user interface for the system. The client-server system 200 includes a plurality of client systems 202, 204, 206 and 208 connected to a server system 210 through a network 212. The server system 210 may be adapted to process and issue signals originating from multiple client systems concurrently using suitable methods known in the computer-related arts. The communication links 214 between the client systems 202, 204, 206, 208 and the server system 210 can be metallic conductors, optical fibre or wireless, without departing from the spirit of the invention.

The network 212 may be any suitable network including a private wired and/or wireless network, a global public network such as the Internet, or combination thereof. In a preferred embodiment of the invention, the server system 210 and the client systems 202, 204, 206, and 208 are located in the same geographic location and the network 212 is private to the organization implementing the system. In an alternative embodiment of the invention, the server system 210 and the client systems 202, 204, 206 and 208 are distributed geographically and may be connected through the private network with a connection to a global public network, such as the Internet. In another embodiment of the invention, the server system 210 is geographically separate from the organization implementing the system as it is run by a third-party company on behalf of the organization. In this embodiment, the server system 210 and the client systems 202, 204, 206 and 208 are distributed geographically and connections between systems may be made using a global public network, such as the Internet.

The server system 210 includes a program element 216 for execution by a CPU. The program element 216 implements similar functionality as program instructions 106 (shown in FIG. 1) and includes the necessary networking functionality to allow the server system 216 to communicate with the client systems 202, 204, 206, and 208 over the network 212. In a non-limiting implementation, program element 216 includes a number of program element components, each program element components implementing a respective portion of the functionality of the system, including their associated GUIs.

Those skilled in the art should further appreciate that the program instructions 106 and the program element 216 may be written in a number of programming languages for use with many computer architectures or operating systems. For example, some embodiments may be implemented in a procedural programming language (e.g., “C”) or an object oriented programming language (e.g., “C++” or “JAVA”).

A user interacts with the system via the client systems 202, 204, 206, and 208, or more particularly, via the user interface provided by those systems. The user interface allows a user to fully utilize the functionality of the system, including accessing avatars and/or goods accessible through the system. In a specific and non-limiting embodiment of the implementation, the user interface is a GUI. The program instructions 106/the program element 216 may include instructions to generate the GUI for the system on the server system 210 and/or the client systems 202, 204, 206, and 208, such as via a Web browser or similar device. Regardless of where the GUI is generated, it typically includes means to deliver visual information to the user via the display unit 110, as well as graphical tools allowing the user to make selections and input commands based on that visual information.

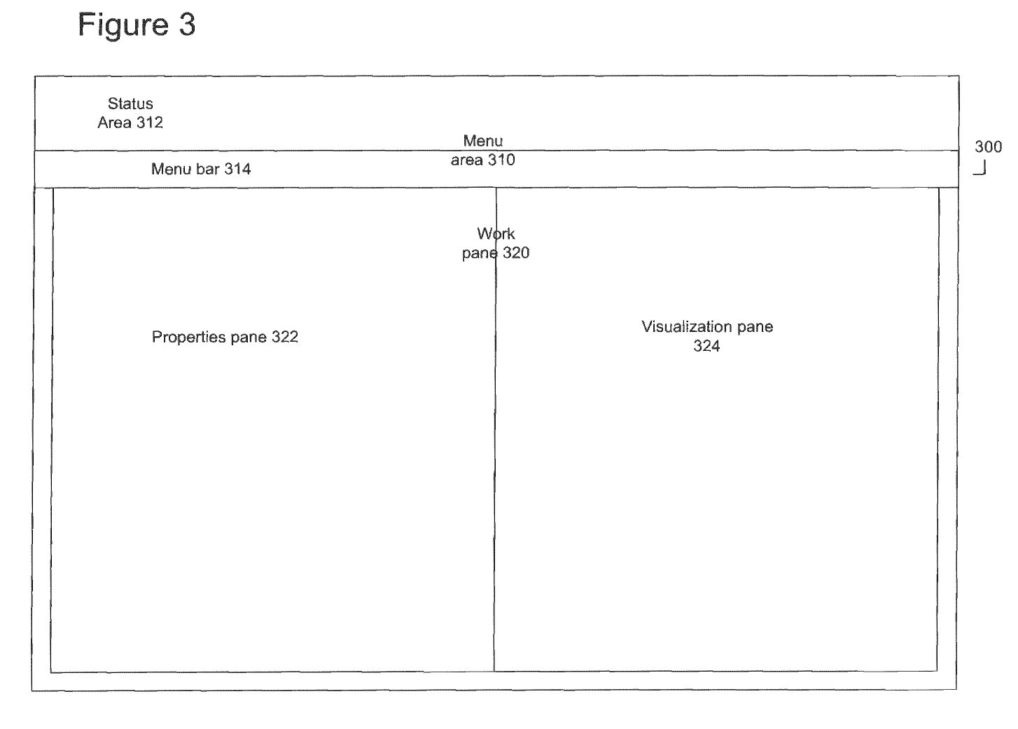

FIG. 3 presents a specific and non-limiting example of implementation of a GUI 300 generated by the system and presented to a user of the system. With respect to this figure, the GUI 300 for the system includes visualization components, which in a non-limiting definition may refer to any method used to provide a presentation to a user or to identify or define an area with a user interface, such as pane, panel, frame or window, among others. It is worth noting that the GUI 300 and its constituent components that defined below may be provided to a user independently or be presented as an integrated part of a larger user interface, such as part of a website for a retail store.

Regardless of how the GUI 300 is presented, its visualization components generally include a menu area 310, and a work pane 320. The menu area 310 contains a status area 312 and a menu bar 314, while the work pane 320 may be further divided into a properties pane 322 and a visualization pane 324. It should be understood that although these components and their related sub-components and the visual indicia included herein may be referred to as panes, areas, menu bars, menus, controls, or menus, these to are non-limiting terms as other visualization components (such as windows, buttons or pop-ups, among others) could be used to achieve the same ends and are intended within the definition of the terms as equivalents.

The status area 312 provides visual indicia (such as logos, pictograms, icons, graphics, pictures and/or text) indicating the organization providing the system, as well as the user status, where applicable. For example, the status area may show an organization's name and logo, the current date and time, as well as the name of the user.

The menu bar 314 provides a set of visual indicia for clickable controls such as buttons and hyperlinks that allow a user access to the different functionality available through the system. Clickable controls displayed here are grouped under common menu items that define categories that may reflect real-world goods, such as fashion items, household appliances, electronics or kitchen cabinets. The menu bar 314 may also contain a search field that allows a user to conduct a search of items available though the system.

The properties pane 322 may contain clickable controls such as buttons, sliders, fields, tabs and hyperlinks. In particular, the use of clickable controls within the properties pane 322 allows the pane 322 to be divided into different panels (not shown), each containing a subset of properties relevant to a item, object or environment selected or identified elsewhere, such as in the menu bar 314 or another panel in the properties pane 322.

The properties pane 322 may also be further sub-divided through visual indicia, such as frames, sliders or dividers into sub-panes, each of which contains a different sub-set of items related to a larger category or group identified previously. For example, the properties pane 322 could represent a set of women's fashion accessories through individual frames for handbags, bracelets/earrings, shoes and scarves, among others.

The visualization pane 324 displays the virtual representation of the avatar(s), objects, items and/or environments selected through the menu bar 314 and/or properties panel 322. As will be explained shortly, the panes 322 and 324 are functionally connected to and making a selection in the properties pane 322 affects the virtual representation displayed in the visualization pane 324 and vice-versa.

The properties pane 322 may also provide clickable controls (such as buttons, checkboxes and/or hyperlinks) to provide a user with access to an online store where items selected for and modelled on a user's avatar in the visualization pane 324. This allows a user to purchase all of the items or objects in the visualization pane 324 from a single point of contact, regardless of the vendors from which items and objects in the visualization pane 324 are displayed, details of which will be provided below.

A typical user's main goal in using the system is for the system to help the user shop for (i.e. locate, evaluate and purchase) goods or items from an organization, more particularly a retailer. While it will be shown that points from which a user accesses the system may differ depending on the situation in which a user finds themselves, their goal of using the system to provide a shopping experience in which they can locate, evaluate, and purchase good(s) or item(s) remains identical. The organization providing access to the system may also be a retailer with physical locations (i.e. retail stores) or an online retailer who has no locations and conducts all business online.

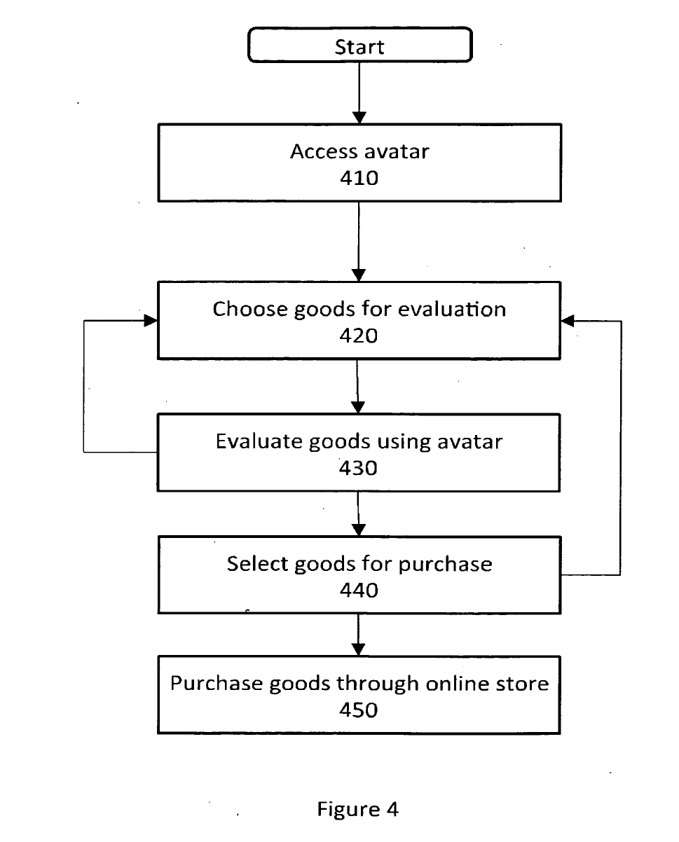

With this goal in mind, one approach to the objective of helping a user locate, evaluate and purchase goods or items will now be presented. In this approach, a user accesses the system from a non-retail location, such as from their home or from an internet café. FIG. 4 provides a flowchart showing the general steps followed by a user in this approach and assumes that the user is displaying the GUI 300 on a display device that is connected to a suitable computing unit 100, as defined earlier. Moreover, the visualization pane 324 is assumed to be showing a default model randomly selected from a group of pre-built model, which can be used throughout the steps explained below.

In step 410, the user selects the avatar they wish to use for their shopping experience. The user may use the menu bar 314 or the properties pane to take one of the following actions:
Use the default model presented as their avatar;
Retrieve an avatar they built previously; or
Build a new avatar to represent them.

If the user chooses to use the default model, they proceed to step 420 and can immediately begin to select goods in which they are interested in evaluating. On the other hand, if the user chooses to retrieve an avatar they built previously, they first enter a set of unique user credentials that were generated a previous session (such as a username and/or password) in the GUI 300 to identify themselves to the system through a set of controls, such as fields. The system then checks the user credentials entered in the field(s) against those saved and determines whether they match. If the user credentials match, the avatar is retrieved by the system and appears in the visualization pane, at which point a user may proceed to step 420 to select goods in which they are interested in evaluating.

Otherwise, the user chooses to build a new avatar to represent them in the system. If a user chooses this action, they are asked to provide relevant personal information to the system through the properties pane 322 that includes physical characteristics such as:
Gender (male/female);
Height;
Weight;
Skin color;
Body type (e.g. thin, athletic, full-featured);
Hair length/style/color
Eye shape/color; and/or
Facial hair, where applicable.

It should be understood that the physical characteristics listed above constitute entries in a non-exhaustive list as other characteristics exist and would fall within the scope of the invention.

As the user enters personal information and physical characteristics in the properties pane 322, the avatar in the visualization pane 324 is updated by the system in accordance with the user's choice. For example, a user who changes the hair color in the properties pane 322 to blond will see blond hair appear on the avatar in the visualization pane 324. In this way, a user can build and tailor the avatar that best to represents their real physical body in a short time with a minimum of specialized information required (such as inseams, collar sizes or arm length measurements).

It should also be understood that although this example uses an avatar, an environment (such as a kitchen) could be created in much the same way and with many of the same methods as explained previously. The only difference is that the physical characteristics a user would enter to customize an environment would obviously differ from those entered to customize their avatar, such as entering their room's dimensions rather than their height and weight.

Once the user is satisfied with their avatar, they can proceed to step 420 or save their avatar for later retrieval. Should a user choose to save their avatar, they may be prompted to enter unique user credentials such as a username and/or password, and possibly other information, such as their name, address, phone number and other contact details.

In step 420, the user selects goods that they are interested in evaluating for purchase using an item presentation visualization component that displays goods available through the system. The item presentation visualization component may appear as an online store panel in the properties pane 322 and can include results of a search performed with a search tool (e.g. the comprising results-presenting component) that is defined below.

The online store panel in the properties pane 322 is comprised of an item-presenting component and a result-presenting component. The item-presenting component contains controls that may include visual indicia such as icons, graphics, picture, as well as clickable controls such as fields, buttons, or drop-down lists. The results-presenting area by default includes all items available through the system, which may include those available from a single vendor, from a pre-defined subset of vendor or from all vendors available. In the context of the system, the term “vendor” refers to an organization that provides goods for sale through the system. It is worth noting that the system may provide access to a single preferred vendor, a predefined set of preferred vendors or to a plurality of vendors with no preference.

to In step 420, the user uses the controls in the item-presenting component to navigate the various categories and types of goods that available through the system and identify characteristics and properties (such as style, size and color) of the goods that they are interested in. As they use these controls, the following occurs:
They narrow the set of the goods displayed in the results-presenting component to those which they may be most interested in evaluating and/or purchasing.
They update the appearance of the avatar in the visualization panel.

Although the user can proceed to the next step and evaluate their selected goods, the system also offers them the opportunity to add clothing that they own to the system. The term ‘virtual closet’ refers to a function provided by the system whereby a user can add 3D models or images of items that they already own to the system which can be retrieved later. Through the virtual closet, the system provides a method for the user to compare the goods they are evaluating for purchase with or against items that they already own. This allows a user to conduct a wider evaluation of a prospective purchase, not just against those items they have selected through the system but also against those items that they already own.

To add items to their virtual closet, the system provides a method the user to use the item-presenting component and result-presenting component to find items that they already own and add it to their virtual closet, such as by selecting or dragging and dropping items (including 3D models and/or two-dimensional pictures) from the results-presenting component to a visual component designated for the virtual closet. Once items are placed in the virtual closet, they can be retrieved by the user and applied to the avatar using the same methods outlined below.

This action leads to step 430, in which the user evaluates the selected good(s) using the avatar in the visualization panel 324 to determine if they like what they see and should continue evaluating the selected good or try a different good instead. The process of evaluation that is undertaken by the user in step 430 to determine the good's suitability for purchase generally involves evaluating the appearance of the good on the avatar as a surrogate for the user's body.

The selected goods that a user wishes to model using the avatar may include items for to which the virtual representation includes a 3D model and items for which the virtual representation includes a two-dimensional picture. When a 3D model is provided for a selected item, the user is provided with a method to apply the item directly to the avatar, such as by dragging and dropping the item onto the avatar's body. When this method is used, the image of the avatar is updated to include the item in a three-dimensional space for which manipulability may be provided to the user. The methods and systems by which the image of the avatar is updated to include the selected item are disclosed in the International Patent Application WO 01/35342 A1, “System and Method for Displaying Selected Garments on a Computer-Simulated Mannequin”, which is incorporated herein by reference in its entirety.

In addition, applying a 3D model of a good to the avatar may allow the system to identify issues, such as problems with the fit of a good such as a garment that may prevent the user from using the item and/or prove unflattering based on their height, weight and body type. The methods and system by which the system can identify fit issues and recommend options to resolve these issues are described in the U.S. Pat. No. 6,665,577 B2, “System, Method and Article of Manufacture for Automated Fit and Size Predictions”, which is incorporated herein by reference in its entirety.

In a non-limiting example of this functionality, assume that a female user tries to apply a 3D model of a skirt in a US women's size 2 to her avatar. Further assume that in step 410, the user created the avatar to reflect her height, weight and body type, all of which indicate to the system that she should be looking for a skirt in a US size 6. Based on pre-determined information about the item and the user's body based on the avatar, the system prompts the user and asks if they would prefer to adjust the size to meet their body dimensions (i.e. increase the size of the skirt from size 2 to size 6). If the user agrees to this, the system increases the size of the skirt and applies it to the avatar. Otherwise, the system informs the user that the item cannot be modelled by the avatar since it will not fit on them due to the incorrect size.

In another related example, assume that the same female attempts to apply a 3D model to their avatar of a jacket in an extra-large size. Based on pre-determined information about the item and the user's body (again, based on the avatar), the system identifies that the user should be looking for the jacket in a medium size, and so prompts her to again to see if she would like to reduce the size of the jacket. In this case, while the size of the item was sufficient to be modelled, the resulting appearance of the oversized jacket may prove unflattering to the user. In these ways, the system is able to identify issues with fit that can prevent a user from ordering goods that are the wrong size that would result in them being dissatisfied. Since returns of goods by customers unsatisfied with the fit of purchased goods accounts for a considerable percentage the returns for retailers in general (and for fashion retailers in particular), the use of such a system could help prevent such returns from occurring in the first place and save the organization both time and money that would be other spent dealing with these returns.

If a 3D model of a good that the user has selected for evaluation is not available, they are provided with a two-dimensional picture (such as an image or graphic) of the item. While such pictures cannot be modelled on the avatar directly, they can be superimposed by the user in a 3D space that allows the image to appear in front of the avatar. While this method does not result in as realistic an image of the item as would otherwise be provided with a 3D model applied to the avatar, this functionality allows the user to get a general sense of how an item may look and may allow the user to make a preliminary decision as to whether it is worth their time to continue evaluating the item further.

However, combining 2D pictures with 3D models through the system can be an effective way for a user to identify opportunities to create related sets of items, such as an outfit created from a variety of different clothes. For example, assume that a male user has applied a 3D model of a green, V-neck polo shirt they wish to purchase to their avatar and is now looking for a pair of jeans that would compliment this shirt. Further assume that based on his criteria, the male user only has two-dimensional pictures of jeans available to him from the results-presenting component. By dragging these pictures over the avatar, the male user can get an idea of how well the jeans/shirt combination would work in general. For example, the male user may realize after several iterations that light-colored jeans are too close to the color of the shirt and do not look good. Based on this information, the user would restrict their search to jeans of a darker color.

The evaluation process may also require evaluating information about the good that is to unrelated to its appearance on the avatar, such as its price, sizing and/or current availability, among others. The system provides several methods through which a user can access additional information about a good that may include the following methods:
Certain information about each good (including the selected good currently visible on the avatar) is provided by default in the results-presenting component, such as its vendor and price;
If the user positions their pointing device (such as a mouse) over a good in the results-presenting component, additional information becomes available in a supplementary visual component (e.g. a pop-up window or frame) such as available sizes, shipping dates, shipping costs.
If the user positions their pointing device (such as a mouse) over a good that is currently visible on the avatar, detailed information about that good is displayed in the GUI 300.

Advantageously, this functionality allows a user to view information regarding the product(s) of interest without having to depart from the graphical environment provided by the system. This allows the user to evaluate and compare different selected goods (which may come from a variety of vendors) within a single interface, without losing the settings or altering the appearance of their avatar by having to depart from the environment to consult other websites or resources.

The evaluation process performed by a user may also include the comparison of prospective goods for purchase against (or with) items that a user already owns. In this case, a user may retrieve items from their virtual closet and apply them to the avatar, which may result in the avatar modelling a mix of prospective purchases and pre-owned items.

The ability to mix-and-match prospective purchases with a user's pre-owned items through the virtual closet in the system is advantageous in that a user can compare and evaluate goods in consideration of what they already own. This allows a user to discover new configurations for sets of related items, such as outfits that could be created by combining a prospective purchase (e.g. a shirt) with an item that they already possess, such as a pair of jeans and a jacket. This functionality also increases the to likelihood that the user will decide to purchase at least one prospective good, especially if the utility of the prospective purchase can be shown to increase the collective utility of other items that the user already possesses.

Those with sufficient skill in the art will appreciate that a user may go through several iterations of steps 420 and 430 until they find the good or item that they are interested in purchasing. For example, the initial iteration may identify the general type of good (e.g. shoes) while subsequent iterations may identify increasingly specific characteristics of this type of good to narrow down the items presented, such as:
athletic shoes; then
pink athletic shoes; then
pink Nike athletic shoes; then
pink Nike athletic shoes in size 7½.

Such iterations mirror the real-world situation whereby a consumer browses a physical retail location (such as a store) to find the general category goods they are interested in and then uses whatever goods available to narrow their search to those items that interest them. In this case, however, the user can be provided with a much wider array of goods than could be stocked and/or kept within a physical store that are available from a similarly wide array of vendors, some of which even the largest retail organization may not deal with or have necessarily even heard of. By providing a wider array of goods that a user can evaluate via the avatar through a single, unified interface, the system can provide a better overall shopping experience to a consumer.

In the following non-limiting example, assume that a user is interested in evaluating winter coats before purchasing one and the item-presenting component presents the following types of winter coat:
Parkas with hoods;
Parkas without hoods;
Winter dress coats; and
Ski jackets.

Further assume that the user already knows that they do not like hoods and they do not to want a dress coat. As a result, the user first selects the visual indicia or clickable control for the “Parka without hood” category. Selecting this category causes the system to refine the set of goods displayed in the resulting-presenting component and update the avatar so he or she appears to be wearing a parka without a hood.

However, the user is unsatisfied with the appearance of the resulting parka on the avatar and so decides to look at ski jackets instead by clicking on the visual indicia or clickable control for this category. The system then updates the results-presenting component to display only ski jackets that are available, while simultaneously updating the appearance of the avatar to show him or her wearing a ski jacket.

The user more satisfied with the ski jacket and so then uses a color changing control or indicia to alter the color of the ski jacket to see what color ski jacket would look best on them via the avatar. They could also use the controls in the item-presentation component to see how different sizes and/or styles of ski jackets (such as those with raised stitching or patterns) would look on them until they were satisfied with their selection and decide to purchase the good.

Once a user is has decided to purchase the good, they select it for purchase in step 440 using a method or indicia identified for this purpose by the system. The method or indicia used to select a good for purchase may include moving the item identified area on the visualization panel 324 or using a control (such as a “Buy Me!” checkbox or button) associated with item in the results-presentation component to add it to a shopping cart operated in the background by the system, among others.

Like its physical equivalent, the shopping cart can contain a plurality of related items of the same type selected by the user. However, the shopping cart may allow the user to organize related goods into sets for evaluation and/or purchase. In the non-limiting example above, the user could have dragged indicia for several different ski jackets matching the appearance of the ski jacket modelled by the avatar to an indicated

“Jackets” area within the shopping cart. This organizational feature helps the user keeps their shopping cart organized, as well as allowing them to more easily compare and evaluate related goods against each other. Since a user can add and remove items from their shopping cart, they can continue to narrow down their selection until only the to good(s) that they decide to buy remain in the cart.

This organization feature also allows a user to assemble a superset of related goods (such as a men's suit comprising a set of goods that include a dress shirt, suit jacket/pants and a tie) based on one or more selected items in the shopping cart. For example, the user in the non-limiting example above could use their selected ski jackets as the basis for purchasing other related goods that would form a winter outfit (i.e. a superset of related goods) that may include the ski jacket, a pair of winter boots and gloves.

In addition, the system can allow a user to share and distribute a picture (a two-dimensional image) of their avatar with the goods that they are evaluating to other people, such as friends, family or colleagues. For example, a picture of an avatar with a completed outfit of clothing can be generated as a JPEG file that could be attached to an email sent to a user's friends or posted to their page on a social networking site for comment by others. Other people could then provide their opinions by email or as comments on a social networking site as to whether they feel that the user should purchase the outfit or not.

In this way, the system provides a method by which a user can generate discussion and obtain the opinions of a wider circle of people about the goods they are evaluating in an asynchronous fashion. For example, the female user identified in the non-limiting example above could use the system to generate an image of their avatar in the ski jacket, gloves and boots. The female user could post this image to her social networking page with a request that her friends provide a “thumbs-up” (i.e. the outfit looks good) or “thumbs-down” (i.e. the outfit looks bad) response. The user's friends may confirm the user's choices (thus increasing the likelihood that she will buy the outfit) or suggest alternative goods that she may not have known about initially, which she can use to modify her choices through the system.

Once the user has selected the good for purchase, they can either proceed directly to step 450 to purchase the good or return to step 420 to choose other goods for evaluation. In addition, goods selected for purchase remain displayed on the avatar to allow a user to see how it will look with other goods. This allows a user to construct a set of related to items, such as an outfit comprised of a set of clothes (or a kitchen comprised of a set of cabinets and appliances, in the case of an environment) through repeated iterations of steps 420, 430 and 440, which is represented in FIG. 4.

Continuing the non-limiting example presented above, assume that the user has selected the ski jacket for purchase, but now wishes to find winter boots and gloves that match the ski jacket. Because the selected ski jacket is still visible on the avatar, the user can use the controls in the item-presentation component to navigate to the winter boots category and model different types, styles and colors of winter boots until they identify and select the boots they want to purchase, which are added to the ski jacket already in the shopping cart. The user would then repeat these steps to select a pair of winter gloves to complete their outfit.

The result of step 440 is that the user's shopping cart may contain a single good from a single vendor, a set of goods from a single vendor or a set of goods from multiple vendors. (In the prior example, the user could have selected a ski jacket from the North Face™, winter boots from Merrill™ and winter gloves from Salomon™) The shopping cart may also provide additional information, such as expected shipping time and/or prices for goods that include taxes, duties and customs fees required for each item. At this point, the user may decide to remove goods from the shopping cart, add more goods through additional iteration(s) of steps 420, 430 and 440 and/or purchase the goods they have selected by proceeding to the next step.

In step 450, the user purchases the selected goods by initiating an online transaction via the system, such as by supplying a shipping address and method of payment (such as by supplying a valid debit or credit card) to the system. Once the system ensures that the method of payment is valid, the system alerts the user that their purchase transaction was successful and may issue an invoice. The system also sends an order for each purchased item in the user's shopping cart to the relevant vendor on behalf of the user so they can pick, pack and ship the goods to the user. This order may include a shipping address, wrapping instructions (in the case of gifts), and information regarding the shipment method to be used for the purchased good.

Once the transaction is completed, the system may offer the user the opportunity to add to the purchased goods to their virtual closet. If the user accepts, the goods are added to the user's virtual closet and they may access the goods they just purchased in later sessions. This is advantageous to the user since the system handles the addition of the goods to their virtual closet automatically.

To complete the previous non-limiting example, assume that the user purchases the ski jacket, winter boots and winter gloves, each of which is supplied by a different vendor (e.g. vendor A, vendor B and Vendor C, respectively). Once a confirmation of payment is received, the system sends the following orders to the vendors on behalf of the user:
An order for the ski jacket would go to Vendor A;
An order for the winter boots would go to Vendor B; and
An order for the winter gloves would go to Vendor C.

In addition, the female user is prompted by the system to add the ski jacket, boots and gloves to her virtual closet. When she accepts, the system adds the 3D model or 2D pictures to her virtual closet so she can retrieve them at a later time and re-apply them to her avatar for use in evaluating future prospective purchases, such as pants that would go with her ski jacket and boots.

Advantageously, the interface by which the user initiates the online transaction to purchase the selected goods (which may be provided by multiple vendors, each of which has their own online ordering system) is provided without the user having to depart from the graphical environment provided by the system. It is worth noting that the methods by which the system uses to process a user's purchase may not be provided by the system directly. For example, if the system is an integrated part of an organization's larger website (e.g. part of a retail store's website) the system may initiate use of other tools available through the larger system to process the user's purchase and initiate a transaction. In some cases, these tools may be provided by a third-party that is independent of the system and/or its parent, such as Paypal or Google Checkout.

The seamless connection between selecting a good or goods, evaluating them through an avatar and purchasing them is advantageous for the user in that they perform these tasks through a single interface. This represents a considerable convenience to to consumers who would otherwise have had to have done the following for each item purchased:
a) Visit the website of or a physical location for each vendor;
b) Find the item for purchase;
c) Ensure that the item is available for purchase in the same color, style and size that is modelled by their avatar in the system;
d) Select the item for purchase, either by electronically adding it to the vendor's online shopping cart or by taking the physical product to a checkout counter; and
e) Initiate individual transactions to purchase and ship the product, where necessary.

Thus, the system saves a user time, as well as increases the likelihood that a user will carry through with a purchase of multiple items from the organization in the future.

In a non-limiting example, the system includes a search tool for enabling a user to identify and find a desired item. The search tool can provide for text-based searching or for visual searching. For example, the search tool can incorporate the technology disclosed in PCT International Application Publication no. WO 2008/015571, incorporated herein by reference in its entirety.

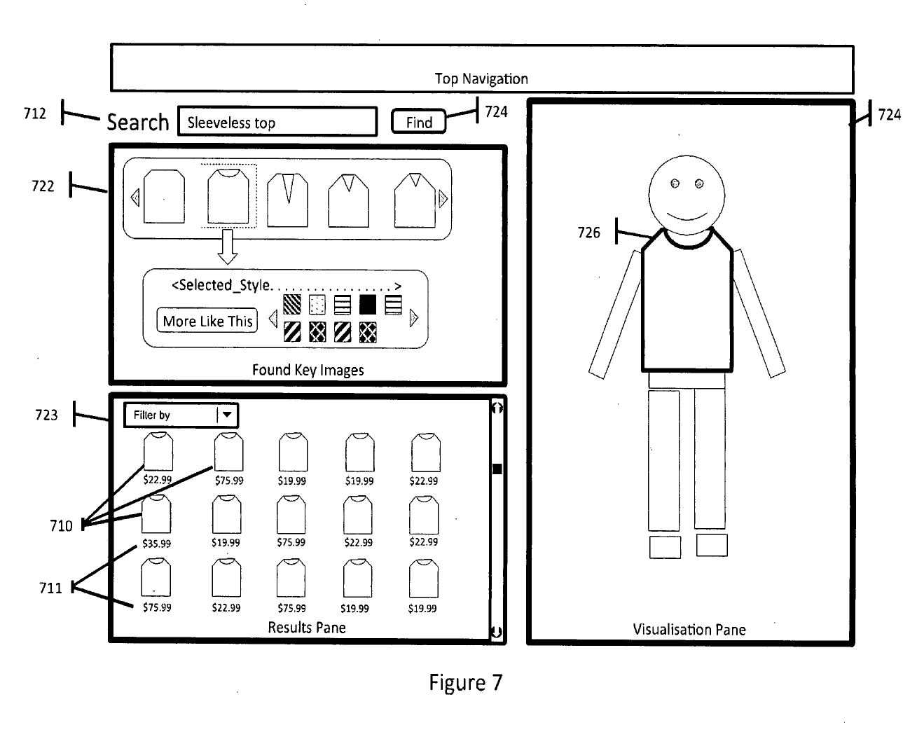

The graphical user interface of the system may comprise a search component for displaying an input-receiving component and a results-presenting component. The search component may be any suitable graphical user interface element such as an area of display, a pane within a window, a separate window, or a combination of both. A non-limiting example of a search interface is presented in FIG. 7. In this example, the search component comprises a search pane 722, which may be a variant of the properties pane described above in relation to FIG. 3, displayed alongside a visualization pane 724 which features an avatar 726.

The input-receiving component may comprise any visual elements for interfacing with a user and receiving a search query. For example, the input-receiving component may comprise any of a number of textual input tools to allow a user to enter a textual search query, such as a text box for receiving a textual input, one or more control such as a to button for initiating a search and a pop-up window responsive to the activation of a control, the pop-up window comprising further controls for setting preferences. Furthermore, the input-receiving component may comprise any of a number of graphical search tools for enabling a user to provide a graphical search query as discussed below. In the example of FIG. 7, the input-receiving component in the search pane 722 includes a text box 712 in which a user can type keywords as search criteria. In the example provided here, a user enters a text indicative of, e.g., desired search parameters. As is known in the art, the text may be made up of keywords that are to be searched for in an index or database. For example, the text may describe an item of interest, such as an item that the user desires to purchase. In one illustrative example, the user enters the description of a clothing item to be purchased such as “sleeveless top”.

The results-presenting component may comprise any visual elements for presenting results of a search to the user, the search being generally, but not necessarily, responsive to a query entered by the user. The result-presenting component may include a visual component such as a pane or window displaying one or more item indicium corresponding to items identified by the search. The results-presenting component may be separate from the input-receiving component such that the search component is divided into at least two portions. Alternatively, the results-presenting component may be integral with the input-receiving component such that the search component defines one continuous visual presentation. In the example of FIG. 7, the results are presented as icons 710 in a results sub-pane 723 of search pane 722. Alternatively still, the results-presenting component may overlap with the input-receiving component. For example, in a non-limiting embodiment, after a first search results is presented, part of the results-presenting component may accept input from a user for defining a subsequent search.

In a non-limiting embodiment, a user initiates a search using a textual search query for a specific purchasable item. The search is initiated by activating an appropriate control such as by clicking on a button such as the “Find” button 714 or by typing the Enter key in a text box. Once the search is performed, the results are presented in the results-presenting component as item indicia. Item indicia may be any suitable indicator of an item and may include text, graphics or both. For example, search results may be to presented in the form a plurality of icons, each having a textual label. In the example shown in FIG. 7, icons 710 each have an associate label 711 indicating a price for the item represented. Alternatively, the search results may be presented as a plurality of textual hyperlinks. In a non-limiting embodiment, the search results include both of these possibilities. Preferably, item indicia include one or more indicium control for initiating an action related to the item corresponding to the item indicia. In the example shown, a first indicium control may cause the selecting of the icon if a user clicks on the icon with a mouse. In an alternate example, selection of the item can be permitted by an indicium control that is a check box nearby the icon. The indicium control can be any other means of indicating a user intent relating to the item and can include a combination of user inputs, such as a click-and-drag routine or a multiple-key keyboard input.

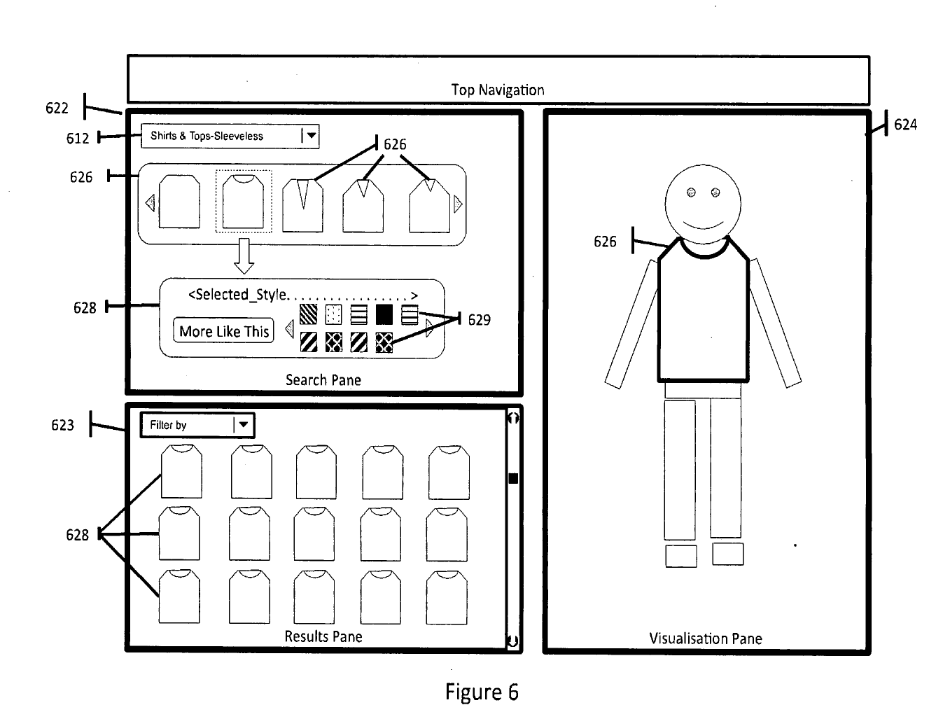

Other means of accepting queries, other than a text box, are possible, such as using a pointing device to identify a text of interest. For example, a user may select a query from a text using a mouse-type device, may select a textual field from a menu, may click on a textual hyperlink or may activate a control (e.g. a button or check box) corresponding to a certain displayed text field. For example, as shown in FIG. 6, a particular text may be selected from a drop-down menu 612.

Alternatively still, the text search may be made up of a combination of different types of textual items such as menus, check-boxes and text boxes. Regardless of the specific input means, it should be understood that a single query may comprise a plurality of textual items. As such, a query may comprise multiple keywords, menu items or fields.

It is to be understood that other non-clothing purchasables may be searched for, such as furniture. Alternatively, items not necessarily for purchase may be searched for. Alternatively still, broader topics that are not necessarily items may be searched for such as information topics.

The search query may be a visual query, wherein instead of using keywords, the user identifies key images. Key images can be identified by any appropriate means. In a non-limiting example, a user is presented with a group of key images from a dictionary of key images (or “pictionary”) in a key images visualization component, from which the to user can select with an appropriate interface tool such as with a pointing device (e.g. mouse click) one or more key image to be used as a search query. Only a group from the key image dictionary may be presented to the user or, alternatively, the entire key image dictionary may be presented to the user. If the entire key image dictionary is presented to the user, it may preferably be organized according to a browsable system such as with expandable categories or according to any other method of browsing images known in the art. Optionally, the particular group of key images to present to the user may be chosen by the system, for example in response to the selection of a category by the user. For example, if the user is searching for a shirt, the user may be presented with a group of key images wherein each key image represents a type of shirt. The category selection can be done by any appropriate category input means known in the art. For example, a user could select a category from a menu, check a check box corresponding to a certain category, or type the name of a category in a text box. It should be understood that there may be subcategories to choose from or that it may be possible to combine multiple categories. Furthermore, the system may also choose the key images to present to the user based on certain characteristics of a user profile, such as his budget or dimensions. Thus shirts that are not available in the user's size may be omitted from the group of key images.

In the example of FIG. 6, a search pane 622 comprises a key image sub-pane 626 where key images 627 from a dictionary of key images are displayed to the user. The key images 627 displayed is a subset of the overall group of key images in the dictionary of key images, selected based on the text query selected in the drop-down menu 612. Here, a category “Shirts & Tops—Sleeveless” was selected in the drop-down menu 612 and only key images of sleeveless shirts and tops are displayed in the key image sub-pane 626. A user can select a particular key image, for example by clicking on it with a mouse cursor. The selected key image is used as a search criterion based on which search results are displayed in the results sub-pane 623. All products matching the key image selected are shown as icons 610 in the results sub-pane 623. Also, upon selection of a key image, an avatar 626 displayed in a visualization pane 624 is shown wearing a piece of clothing corresponding to the key image.

Optionally, the selected key image is then displayed in a details sub-pane 628 where additional search criteria can be entered. As shown, a plurality of colors panels 629 can to be shown in the details sub-pane 628 such that the user can select a color associated with the key image. Selecting a color, for example by clicking on a corresponding color panel 629 causes the piece of clothing displayed on the avatar 626 to adopt the selected color and may optionally cause the search results shown in the results sub-pane 623 to be narrowed to only those products available in the selected color or in similar colors.

The use of key images can also be combined with other means of accepting queries, such as with the textual input shown in FIG. 7. Other query input means such as selectable buttons corresponding to categories of clothing items can also be used in conjunction with key images. It is also to be understood that the elements of the search query shown here need not be combined in the manner shown. In an alternate embodiment, a search may comprise only a textual query without key images or only a key image query without other input means. Furthermore details sub-page 628 may be completely absent.

In a non-limiting embodiment, the user may input a key image using an appropriate image input tool. The image input tool may be a file selector that permits the user to select a file containing an image to be used in a query, or it may be a drawing application that allows the user to define visually the key image. Visual recognition techniques known in the art may be used to identify an image or to classify it into one or more category of images. Alternatively still, the image input tool may provide the user with a plurality of options to chose from to create a key image. As such, the image can be formed from a template or from a plurality of templates where certain templates may correspond to certain portions of the key image or of the item the key image represents. For example, if the user is searching for clothes, the image input tool may allow the user to select a type of clothe (e.g. shirt), and to select certain components thereon (e.g. chose a type of collar from a plurality of collars, a type of sleeves, overall cut, sleeve pleats, cuffs, buttons, monogram, etc...). The selection of components on the item can be done graphically (e.g. click on an image of a preferred type of sleeve or drag an image of sleeves onto a shirt) or textually (e.g. select “French cuff” from a menu) using any of the textual input means described above in relation to textual searching. Furthermore, the image input tool may also accept certain values, such as numerical measurements.

to Whether the key image is created from scratch or from templates, the key image may be customizable on by the user, as shown in FIG. 9, which illustrates an exemplary customization tool 900. In the example of FIG. 9, the user has previously selected a “t-shirt” category, and is presented with a blank t-shirt in a visualization pane 910. Key image or other images corresponding thereto may be displayed in the key image visualization component or in the visualization pane, as described below. Here the customization tool is a stand-alone pop-up window which comprises a display pane 910 showing the key image 908 being customized It will be appreciated that the customization tool can also be presented in other means, such as in panes integral with other portions of the graphical user interface.

In a non-limiting embodiment, the key image may be customizable graphically or textually. For example, a user may provide characteristics of the item represented by the key images textually, by selecting them from a pull-down menu or other text-representing selection tool. For example, a user may select an item dimension, such as a shirt collar size by entering it into a text box. Preferably, the item key image is graphically customizable. In a non-limiting embodiment, a key image customization toolset is provided to the user for customizing a key image. The key image customization toolset may include various controls, visualization components, selection mechanisms as needed to customize at least one key image according to certain user preferences. For example, a user may be able to select a certain portion of an item to customize by identifying it with an appropriate selection device such as a pointing device. A portion of an item to customize, such as a portion selected as mentioned, may be customizable discretely. In other words, there may be a discrete number of different customizations possible, and each customization may potentially lead to a different visual representation being presented. In fact, by customizing a certain aspect of the key image, the key image itself may be replaced by another key image (e.g. from a database of key images) such that although it appears to a user as though a single key image is being customize, the user is actually cycling through different key images, each having its own characteristics, during customization. In an alternate embodiment, a key image may have certain variables associated with it, the variables corresponding to certain customizable aspects of the item related to the key image such that the same key image remains even as the user customizes it using the customization toolset. In the example of FIG. 9, the customization tool 900 comprises a custom details pane 912 where a to user can select a gender by clicking an associated radio button 914, type in a neck size in a corresponding text box 916, select a fit type in a pull-down menu 918 and select a color by clicking on an associated color panel 920. The key image 908 being customized is changed according to the details inputted in the custom details pane 912.

The customization toolset may also provide the user with a control directly on the image of the t-shirt. For example, a user may change the collar of the t-shirt by selecting the collar with a selecting device, such as by clicking on it with a mouse, whereupon a textual description or graphical visualization of the various options may be presented to the user. The visualization may take the form of a pop-up or may be a pane that is created or merely activated and made to contain the representation of the options to a user. In the example shown in FIG. 9, the user has clicked on the collar portion of the key image 908 being customized and a pop-up pane 922 displaying various existing collar types is displayed. Also shown in FIG. 9, the various existing collar types may alternatively or additionally be displayed in a side visualization pane 924, or indeed in any other suitable manner. A user may go one to customize other aspects of the t-shirt such as sleeve length, bottom cut, fabric type, brand, etc . . . Graphical customization may be done with the key image visualization component, in the visualization pane or in any other visualization component such as a customization visualization component provided for that end. Although this example relates to the fashion industry, the system can apply equally well to other industries such as the furniture and household items industries.

In a non-limiting embodiment, the customization functionality described above is used to implement a key image hierarchy. In this example, key images may be organized into a hierarchy according to the number of customizations required to obtain the key image when starting from a base or root key image. To this end, the possible customizations may be ordered such that they each correspond to a level in the hierarchy. For example, all t-shirts may be organized in a t-shirt hierarchy where the root t-shirt is a plane white t-shirt. Before obtaining the root t-shirt, certain other parameters may need to be set, such as whether we the t-shirt is a men's or women's t-shirt. From the key image of the root t-shirt, the user may begin customizing until a desired product is obtained. If the possible customizations are ordered, the user may be sequentially made to select a customization for each possible customization. In such a case, the user may have to first to select a color or pattern, following which the user will be made to select a cut, collar, sleeves and embroidery. In non-limiting example, it is not necessary for the user to specify a customization everywhere possible, but if a user does not have, e.g., a sleeves preference, the user may skip such customization step. Also, it is not necessary for the order of customization to be set, but a user may be able to use the customization toolset to customize the item as desired in any particular order. Although the example provided here relates to the fashion industry and particularly to a t-shirt, it is to be understood that this system may be applied to other industries such as the furniture and household items industries.

In a non-limiting embodiment, the system may comprise, or otherwise have access to, a database of key images that may be searched using any appropriate means, such as using the textual search described above. In this example, a textual (or other) search performed may provide along with the search results a group of key images corresponding to the search parameters as defined in the search query. In such a case, the key image visualization component may be contained within or overlap the results-presenting component. Thus in a non-limiting example, a search performed with the search tool described above may identify key images as well as search results such as items searched for. In this example, the search results may also comprise non-key image results, the key images being presented alongside search results in the results-presenting component or in a separate section of the results-presenting component. The key images presented with search results may not be related to the search results. For example, the group of key images presented along with the search results may simply have been identified using the search query and a database of key images. Alternatively, the key images may be related to the search results. For example, all key images may be linked to certain search results, and only the key images having a link to the results of a search are displayed with the search results. In another example, the group of key images presented along with search results may include only key images that correspond to one or more search result. A key image may be considered to correspond to a search result if any appropriate correlation criterion is met. For example, a key image may be considered to correspond to a search result if a search using the key image as query would have identified the search result.

In a non-limiting example, key images, or other images corresponding to key images, to such as blown up or 3D versions of the key images, may be displayed on the visualization pane. This may be done automatically, upon the selection of a key image for searching using a key image control, or by the activation of another key image control associated with a key image. A key image control may be any user-activable control such as a clickable control, or a combination of clicking and dragging. Thus a user may be permitted to cause the display of a key image in the visualization pane by clicking and dragging a key image into the visualization pane. Key images displayed in the navigation pane may be displayed as part of another display in the navigation pane, such as on an avatar or in a representation of a room. In such a case, the image shown in the navigation pane may include may correspond to the key image but not be identical to it. For example, if the user is searching for a shirt, the shirt key image may be displayed as worn by his avatar, if present, in a 3D visualization in the visualization pane. Likewise, a piece of furniture being searched for using a key image may be shown as part of a room shown in the visualization pane.

Once a user has formulated a search based on key images, the system performs a search for items matching the key image. In a non-limiting example, the system translates the key image or key images into a textual query for searching in indexes or databases. In a non-limiting embodiment, the key images are each associated with one or more textual element, such as keywords. The keywords to associate with each key image may have been identified in advance by an expert that is familiar with the nomenclature of the field(s) to which the key images relate. For example, a fashion expert may have associated fashion terms to a set of clothing-related key images such that a user that is not familiar with the proper terms used in fashion may still be able to search with precision using the visual definitions provided by key images. In this example, the unversed user becomes as effective as a fashion expert in searching out particular styles. As such, a user wanting a three-button single breasted sports jacket with notch lapels and houndstooth check may accurately search for such an item without necessarily knowing all the terms to describe it. The specific keywords associated with a key image may be fixed or may depend on the database being searched. To this end, a key image may be associated with several sets of key words each set being usable for searching at least one database, or alternatively, the keywords associated with a key image may undergo automatic transformation, such as translation with a dictionary or lookup table, at the time of searching, the transformation being dependent or independent upon the to specific database being searched. Furthermore, a key image may be associated with keywords in different languages such that different language databases can be searched without requiring the user to understand the language of the database. One will appreciate that a user may also search a single (e.g. English) language database visually even if the user does not speak English.

Furthermore, a key image search may be supplemented or more precisely targeted by the addition of textual search parameters, such as text key words or textual filters. For example, a user may select dimensions from a drop-down menu or may similarly select or type in the names of desired brands.

In an alternate embodiment, the system may translate every feature of an item into a textual or numeric value and search that value in the field of a database corresponding to that feature. For example, the system may identify a type of cuff, collar, buttons, cut and size of a shirt in a key image (some of these may be wildcard, e.g. if “any type” of cuff will do) and search a database where different shirts are classified with corresponding cuff, collar, buttons, cuts and sizes. Alternatively, the system may translate the key-image into one or more keywords and search one or more databases for any entries appearing to contain that keyword. For example, the system may search multiple clothing store databases for entries containing the words “shirt” and “French cuff”. Key image searching is merely optional and these search mechanism are provided only by way of examples. Other possible mechanisms are provided in PCT International Application Publication no. WO 2008/015571 mentioned above and incorporated herein by reference in its entirety.

The search tool may search databases internal to the system or external to the system. For example, the system may have a database of items for purchasing and a user be expected to search purchasables with the search tool. In such a case, the search query may be used only with the internal database. Alternatively, the system may search through external databases such as databases of purchasables from third-party stores or employ third-party data indexing tools. Furthermore the search tool may be entirely internal to the system or may comprise external components such as third-party search engines.

to In a non-limiting embodiment a textual (or other) search can potentially provide a large number of results. For example, if a user types in a keyword for a popular item of which there exist many types, the search may identify too many items to practically consider them all. In a non-limiting embodiment, it is possible to further target a completed search based on the results provided. In such an embodiment, the search may be a process of multiple steps where the first step comprises the original query and further targetings form the additional steps. Targeting a search may involve narrowing the search results, such as by discarding a subset of the search results. This can be done, for example, by eliminating those results that do not match certain criteria or that lack certain features, or by performing a second search within the search results such that the parameters of the second search (e.g. search query) are only applied to the results identified in the first search. Alternatively, targeting the search may involve running a new search that is expected to provide more search results (or more specifically relevant search results), fewer search results (or fewer specifically unnecessary, undesired or irrelevant search results) or search results that better correspond to a search target (e.g. search results more correlated to search parameters or search results related to new and more relevant search parameters). Alternatively still, targeting the search may involve selecting a subset of a plurality of originally-searched databases, in which the targeted search results should be. Any alternative method of targeting the search may be employed.

In a non-limiting embodiment, the search results may be employed to target the search. For example, in a search for items, a search that has identified a certain number of items and presented corresponding item indicia may be narrowed by the activation of a targeting indicium control by a user. In this case, a user may select a certain item and by activating the targeting indicium control, the user indicates that the corresponding item is particularly relevant or that more items of the type selected are to be found. The system then accordingly performs a search targeting, as described above. It is to be understood that search targeting may be performed on the basis of more than one search result. For example, a user presented with multiple item indicia may indicate with targeting indicia control (such as check boxes near the item indicia) multiple items around which to target the search. For example, if a user searched for dresses and was subsequently presented an overwhelming number of dresses, the user may then select one or more dresses that correspond to the style the user was interested in (e.g. cocktail to dresses, or more precisely black cocktail dresses, or alternatively strapless dresses). The search is then targeted towards those particular dresses.

The targeting mechanism may be textual, graphical, or both. In an example of textual targeting mechanism, text from the name, description or otherwise related to a search result is employed for targeting. For example, such text may be used as a search parameter (e.g. keyword) in a subsequent search, or to be analyzed by a narrowing process (e.g. remove result if text doesn't contain a certain expression). A search may be textually targeted by running a n new search on the basis of a new text query that better defines the desired search results, by running a search within the search results using a textual query, by eliminating a subset of results on the basis of their association or non-association with certain textual element (e.g. presence or absence of certain text in their title/description), by adding additional search results found using a textual query, or by any other appropriate means.

Alternatively, the targeting mechanism may be graphical. To this end, targeting may invoke visual methods such as visual searching as described above or visual narrowing techniques. In a non-limiting embodiment, elements presented by the results-presenting component may be used as key images on which to base an additional search (within or without the search results) or with which to narrow the search results. The elements used as key images here may be actual key images identified in the search as described above, or search results comprising a graphical component to be identified by the system as a key image. In order to employ a graphical component of a search result as a key image, the system may invoke any appropriate visual recognition or classification techniques as are known in the art. Alternatively, the system may identify a key image associated with the search result (such as a key image that corresponds—as described above—to the search result).

A graphical targeting mechanism employs one or more key image to target the search. The search may be targeted by running a new search on the basis of the key image(s), by running a search within the search results on the basis of the key image(s), by removing a subset of results not associated or associated with the key image(s) or by adding additional search results found using the key image(s).

As stated previously, the overall goal of a typical user of the system is to have the system help them shop for (i.e. locate, evaluate and purchase) goods or items from an organization, and more particularly from a retailer. The preferred embodiments presented above have taken the approach that a consumer starts with virtual representations of physical goods that are stored within the system to select, evaluate and purchase such goods, which are then shipped to them once the purchase transaction is completed.

In an alternative configuration, however, the consumer can start with physical goods they have selected and use the system to evaluate them based on their virtual representations. This configuration allows a consumer to use their avatar as a custom-tailored mannequin that they can then use to determine the suitability of in-store goods for purchase without the need to actually try the good(s).

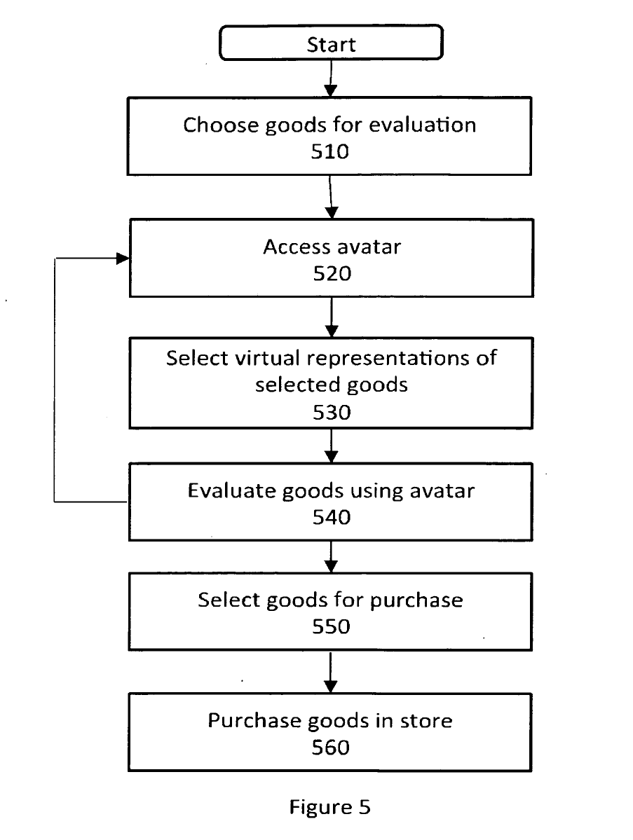

FIG. 5 represents a block diagram showing how the system is used within the shopping experience for this embodiment. It is worth noting that certain assumptions in this embodiment differ slightly from earlier embodiments in the following ways:
Access to the system is provided in a location selected by the organization, such as their representative store or outlet, rather than a location selected by the user (i.e. a retail store rather than the user's house or internet café);
Access to the system may be provided by the organization rather than by the user themselves (i.e. the client systems 202, 204, 206 and 208 may be computers located in a store or retail outlet); and

In step 510, the user selects physical goods within the retail store or retail outlet of the organization that they are interested in evaluating using the system. With respect to FIG. 4, the user's selection process in this step differs from that outlined in step 420 in that they are selecting goods that may be limited to goods that are physically located in the store, which may represent a subset of the total vendors that would otherwise be available through the system. While a user may simply carry selected physical goods with them to the computing unit 100 in the store designated as an access point for the system, a preferred method would be to provide them with a scanner, such as a barcode scanner/pen or RFID (Radio Frequency ID) reader, which would be used to identify the to goods in which the customer is interested. The output of the scanner would be tied to the customer's store fidelity card number (or any similar method that is used by an organization to uniquely identify customers), such that any good the customer scans/reads to signify their interest would be tied to their fidelity card. This method allows a customer to browse and select goods without actually having to carry the physical goods to the system, and could also be used to allow the customer to evaluate goods that are considered too expensive or would be otherwise impossible or unwieldy for them to carry, such as very high-end handbags, shoes or electronic items.

In step 520, the user accesses the system and chooses (or creates) their avatar using a computing unit 100 provided by the organization. Since the process by which the user accesses their avatar has already been disclosed in step 410, this process need not be repeated here. However, it is worth noting that the system allows a user to create their avatar in one location and use it in another location, such as when user creates their avatar while at home but retrieves it while shopping at the store. Through this method, the system provides convenience to a user who may otherwise not have access to the system to help them while shopping. This also provides an incentive for shoppers to visit stores and retail outlets of the organization that are equipped with the system, thus driving up store traffic and increasing the potential for additional sales.

It is also worth noting that the appearance and capabilities of the computing unit 100 provided by the organization for system access may differ from a household desktop or laptop computer that would be used in previous embodiments. For example, the display unit 110 of the computing unit 100 in this configuration may be comprised of a screen (or a set of screens) that are large enough to provide a user with a life-sized display of their avatar. In addition, specialized equipment may be connected as I/O devices 108 to the computing unit 110, such as devices that identify the user's hand movements and replicate them as pointing devices on the display unit 110, or a body scanner that can scan the full-length of the user's body and use the measurements identified to automatically configure their avatar to best match their height, weight and current body type, among others. While the system considers all computing units to be identical and provides the same general functionality to each of the units 100, the provision of such units by the organization may increase the likelihood of usage by consumers who come across them in a store or retail outlet. This may also increase traffic to stores or retail to outlets that are equipped with the system as consumers who have used the system previously may prefer to visit a store where this system is available.

In step 530, the user locates and selects the virtual representations of the physical goods they have selected. If the user selected their goods using a barcode scanner/RFID scanner or similar device in step 510, they can communicate their selected goods to the system by merely identifying themselves through their customer fidelity card. For example, the user could scan or swipe their customer fidelity card through a card reader attached to the system in order to retrieve the virtual representation of the good(s) that they had scanned earlier.

However, if the user carried the selected physical goods they wish to evaluate to the computing unit 100 that has access to the system, they need to use a method to identify their selections to the system. The methods by which this location and selection process are performed may be the same as those identified previously in step 420, through use of the indicia and controls within the item-presentation component and/or the results-presentation component to identify goods. However, the array of goods provided in the item-presentation component in this implementation is likely to be restricted to those that are physically available in store and/or are available through the organization, such as the contents of a department store's catalogue.

In certain cases, the user may bypass the controls item-presentation entirely if some method for communicating a unique identifier (such as a SKU number or barcode) to the system is provided. In an example of a non-limiting configuration that could be used for this purpose, a barcode scanner could be connected to the computing unit 100 in order for the user to scan the barcodes of each good they wish to evaluate. The system would use the barcode data to retrieve the virtual representation for the good and display it in the results-presentation component, as well as on the avatar in the visualization pane 324. In another non-limiting configuration, RFID tags attached to (or enclosed within) each good could be passively read by an RFID scanner connected to the computing unit 100 so that virtual representations of all physical goods selected by the user could be identified and retrieved by the system in a single pass.

Regardless of the method used to identify the goods selected by the customer to the system, the result of step 530 is that virtual representations of all selected goods become available to the user through the system. In step 540, the user evaluates the goods they selected previously using their avatar. While the methods by which a user evaluates their selected goods using the avatar (and/or other functionality available through the system) have been described previously, it is worth noting that in the context of a retail store or outlet, the system allows a user to evaluate and compare a set of items to identify and target those goods that the customer deems worthy of further effort in evaluation. Depending on the type of goods being evaluated, this may save a customer considerable time, especially in situations where access to other evaluation tools (such as dressing rooms) is limited or impossible.

For example, assume that a female user selects 20 swimsuits for evaluation in the system to see how they appear on her avatar before she tries them on. By having her avatar model the swimsuits she has selected, she immediately notices that two-piece swimsuits (such as a bikinis) really do not flatter her figure so she removes these from consideration. Of the remaining one-piece swimsuits she has selected, she finds that only two (2) of them appeal to her due to their color, shape, style and appearance on her figure. By using the system, the customer has saved herself the time and effort needed to test 18 of the swimsuits and now only has two (2) to try on. This can represent considerable savings for users at times when access to other evaluation tools (e.g. dressing rooms, store clerks and/or checkout counters) is at a premium, such as during peak holiday shopping periods.

It is also worth noting that the user who is evaluating clothing to purchase within a retail store or outlet has access to their ‘virtual closet’ in the system containing virtual representations of goods that they already own. This functionality allows the user to mix-and-match goods (such as clothes) that they are currently evaluating with those that they have already purchased to see whether potential purchases would work with their current set of purchased items. For example, assume a male user owns a black and blue chequered sports coat and is evaluating a set of shirts that are various shades of blue in the store. By accessing the sports coat from their virtual closet and applying it to their avatar, they can model each shirt and see how it looks with the color pattern of their sports coat. In this way, the system allows a user to not only identify related goods that would work well together in the store as an outfit, but also create additional outfits by to mixing-and-matching goods in the store with goods that the user has already purchased.

This functionality may help an organization make additional sales (since a user may purchase more goods if they work well with already purchased items) and lower the return rate, since a user knows that the utility of a purchased good will be leveraged through the items that they already own.

As indicated in FIG. 5, it is likely that several iterations of steps 520, 530 and 540 occur before a user decides on the goods that they wish to purchase. In step 550, however, the user selects the goods that they decide to purchase by adding these goods to a shopping cart. If the user carried the selected physical goods to the system in step 510, they already possess the physical goods they wish to purchase in a physical shopping cart and need only to proceed to the checkout to purchase the goods in step 560.

On the other hand, if the user selected goods in step 510 using a barcode scanner and/or RFID reader, they do not actually possess the physical goods and so must use a virtual shopping cart to hold the goods that they wish to purchase. The methods by which the user moves their selected items to a virtual shopping cart were documented earlier and need not be repeated here. Once a user's items are in the virtual shopping cart, the user (or a store employee) can locate their physical counterparts in the retail store or outlet or submit the list of goods in the cart as an order that will be fulfilled elsewhere, such as through a shipment from a warehouse to the customer or in another store.

It is worth noting that the system can alert the user (and/or employee) of opportunities based on the contents of the shopping cart, such as a mobile coupon that is discussed in more detail below. However, the system may be able to identify opportunities such as items that a user may have missed selecting and/or evaluating and make recommendations to the user based on these omissions. In a non-limiting example, assume that a male user selects a suit jacket, pants and shoes through the system and adds these to his shopping cart. Based on pre-defined rules that identify the components in a men's suit, the system notices that the male user is missing a dress shirt and tie that would otherwise complete their outfit. The system prompts the user that they have missed these two items and asks the user if they would like to select and evaluate goods representing these items. If the user signals that they would like to assistance, the system can either alert a store clerk for assistance or recommend goods for the user's evaluation based on pre-defined rules, such as recommending a white or light blue shirt and red tie for the navy blue suit that the user selected for purchase. Otherwise, the user signals that they are happy with their purchase and the process moves to the next step.

In a related variant to the above, the system can use the opportunity to ‘upsell’ a customer by convincing them to purchase a more expensive item. For example, assume that the male user identified in the non-limiting example above selected a pair of low-end dress shoes as part of their intended purchase. Based on a set of pre-defined rules, the system may realize that the expensive suit jacket and pants the user intends to purchase indicates that an opportunity exists for the user to be sold on a more expensive pair of shoes. Realizing this opportunity, the system prompts the user asking them if they would like to see other (e.g. more expensive) dress shoes that would better compliment their suit or represent better value. If the user signals that they would like to take advantage of this opportunity, the system can present a set of shoes that are more expensive than the shoes the customer intended to purchase initially (or similarly alert a store employee that this opportunity exists). It is worth noting that noticing an opportunity to upsell a user can trigger the use of other sales tools and methods (such as the mobile coupon that will be discussed below) to convince the customer and complete the sale.

While the non-limiting example presented above identified opportunities and made recommendations based on omissions that the system identified in a user's shopping cart, other factors could be used to identify opportunities, such as a user's body shape and/or assumed lifestyle. Those with sufficient skill in the art will understand that other factors could also be used by the system to identify opportunities and that these would be covered by the scope of the invention.

In step 560, the user purchases the goods and completes the process. This step is identical to step 450 with the obvious exceptions that the transaction is executed in a physical location rather than an online store, and that purchased goods may be provided immediately rather than there being a delay due to shipping.

In a non-limiting embodiment, personalized coupons may be offered to a user by the system. Coupons may represent any advantage conferred to user. In a non-limiting example, the coupon represents a discount on a purchase. The discount can have any of a number of conditions attached to it, such as being limited to a specific item, being limited to a specific time frame, being applicable only to purchases in a certain price range, etc . . . Besides a discount, the coupon can represent many other advantages such as the offer of a free good or service, the offer of a prize, an upgrade to a good or service, or any incentive, reward, or compensation. The term coupon is not intended to be limited to a traditional paper coupon, in fact is may be completely paper-less. Rather, the term coupon may refer to the offer presented to the recipient of the coupon.

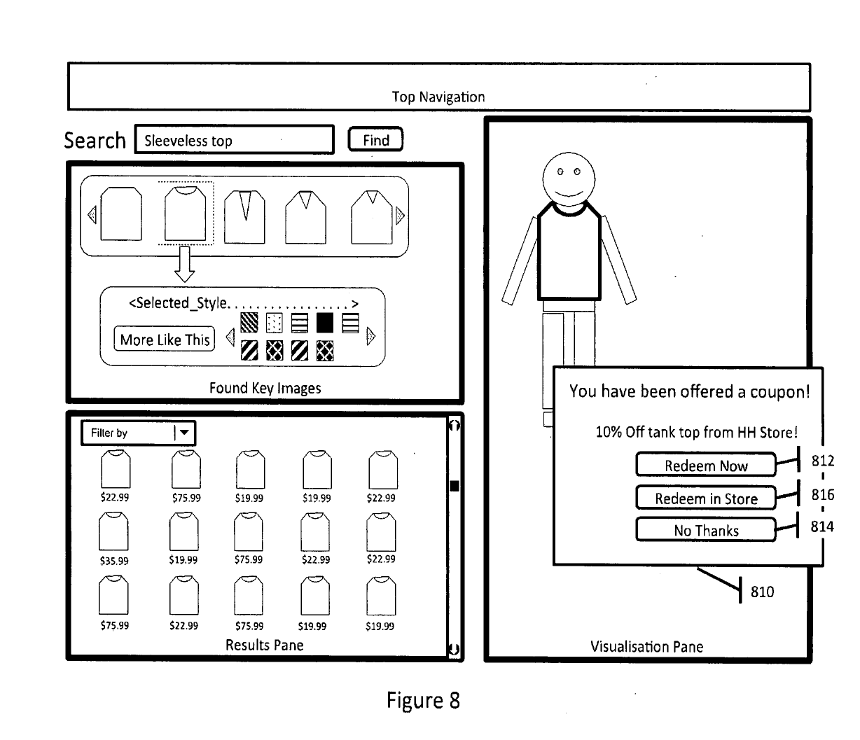

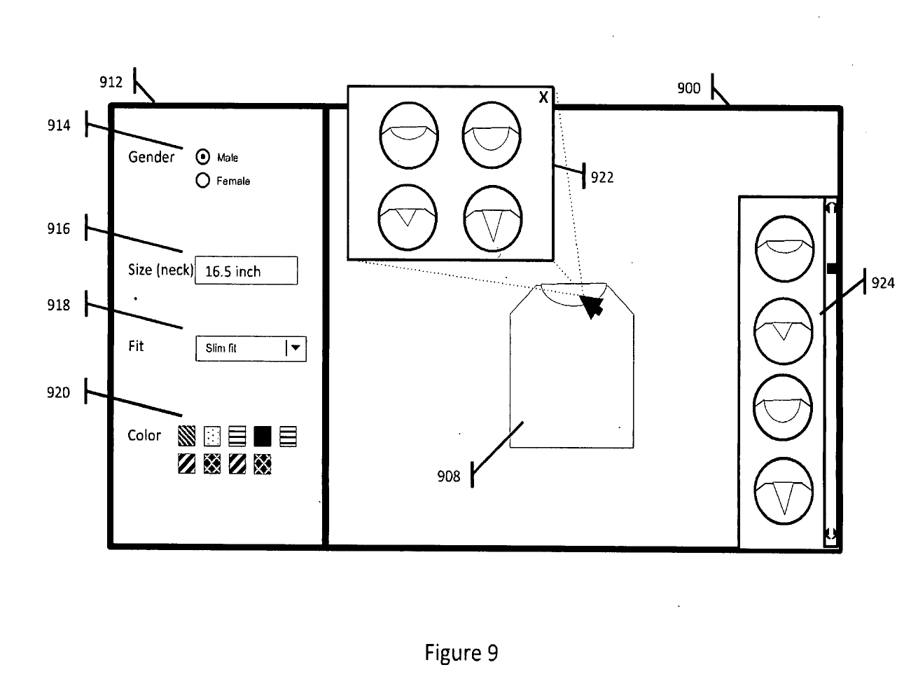

A user using the system e.g. for shopping, may be offered a coupon electronically by the system. In such a case, an appropriate graphical user interface component may advise the user that a coupon has been offered to them. The coupon alert may be any suitable way of notifying the user may be employed and in a non-limiting embodiment, a pop-up or a message displayed in an alert pane or window informs the user of the offered coupon. For example, as shown in FIG. 8, a pop-up coupon alert pane 810 is displayed by the system. The coupon alert may also be sent by electronic mail, regular mail (as a paper coupon) or by any other suitable manner including other forms on internet messaging. It is to be understood that the coupon may be provided by multiple means, via multiple different coupon alerts. Thus a coupon alert showing up as a pop-up may be followed up with an e-mail offer.

In a non-limiting embodiment, the coupon alert includes an interaction means which includes a means by which the user may chose to accept the coupon. The interaction means may include a link to a purchasing window where a purchase can be completed with under the offer of the coupon. Alternatively, the coupon alert may comprise a button for accepting the offer, the pressing of the button causing the eventual purchase of a coupon-discounted item (or otherwise acceptance of the offer) directly by completing the purchase, or indirectly by adding the item under the offer in a shopping cart. In the example of FIG. 8, the pop-up coupon alert pane 810 includes a “Redeem Now” button 812 that allows the user to initiate the purchase or the browsing of coupon-redeemable items. A person of ordinary skill in the art will readily appreciate that many other possibilities for enabling acceptation of the coupon are possible, all of to which are within the intended scope of the invention.

The interaction means may include a means for refusing the offer. In such a case, a user can elect to refuse the offer or, optionally, to postpone acceptance of the offer to a later time. Any suitable control can be provided for this end, such as a “No Thank You” button, such as the “No Thank You” button 814 shown in FIG. 8.

In a non-limiting embodiment, the interaction means includes a means for transferring the coupon from an online version to an in-store version. Here, the coupon may originally have referred to an offer to be redeemed in an online purchase. However, a user may want to buy from a physical store. There are many potential motivations for a user to chose not to buy online but to buy in a store, amongst which include the case where a user may not have the appropriate transactional equipment to buy online, may not trust online purchase mechanism, may not want to buy an item without trying it on physically, or may simply chose not to buy an item for now, but wants to maintain the possibility of using the discount at a later time. It is to be understood that the term store may refer to any provider of a good or service. The transfer of the coupon to an in-store version may be initiated by a “Redeem in Store” button 816 as shown in FIG. 8, or by any other suitable means.

By activating the transfer of the coupon using the means for transferring the coupon, a user obtains a coupon that may be redeemed in a physical store. In a non-limiting embodiment, the coupon is intended for a specific user and may be unique or semi-unique to the user. A coupon that is semi-unique to a user is unique to a subset of users comprising the user. A plurality of users that have one or more certain matching traits such as a behavioral pattern may each be offered the same coupon. In this case the coupon is said to be semi-unique because it is unique to the group but not within the group. While the offer of the coupon may be unique or semi-unique, it is not necessary for the offer to be unique for the coupon to be considered unique. Rather, the coupon may merely include a unique identifier. A coupon may comprise a code which may be indicative of anything related to the coupon including the offer of the coupon, information on the user to whom the coupon is intended, information on the reasons behind the offer of the coupon or indeed any other information. The code may be an alphanumeric sequence (e.g. represented by a bar code, or represented via to electromagnetic waves) or any other representation of the information the code relates to. The transfer of the coupon can be done by any means that allows a user to subsequently redeem the coupon in a store. In a simple example, the user is merely provided with a unique or semi-unique code to provided to the store in order to redeem the coupon. Alternatively, the transfer of the coupon may involve printing out a paper coupon, such as a printout comprising a bar-code indicative of a unique or semi-unique code. In yet another alternative, the transfer of the coupon may involve the registering of the user with the store such that when the user identifies themselves at the store, the offer may be extended to them.

In yet another alternative, the transfer of the coupon may involve the sending to a cellular phone or other portable electronic device, the code for redeeming the coupon in the store. The code may be sent via a coupling (e.g. RS 232, Bluetooth™) between a computing device with which the user accesses the system or may alternatively by via a cell phone communication system, e.g. by SMS. The system, may either have previously stored the user's contact information including the user's phone number or may request the required information to transfer the coupon upon initiation of the transfer via an appropriate graphical user interface tool.

Once received on the user's portable electronic device (e.g. cell phone), the user may present the coupon code at a store to redeem the coupon. In a non-limiting embodiment, the portable electronic device may be made to display a bar code that can be scanned by a bar code scanner. Alternatively, the code may be provided to the store via Bluetooth™, infrared or simply copied from a display on the portable electronic device.

In an alternative embodiment, the user does not directly cause the transfer of the coupon, but the system chooses to send a coupon to, e.g. the user's cell phone under certain circumstances, such as after the user logs off (or after the user logs off having not purchased an item that the user spent a lot of time visualizing).

Furthermore, the system can provide coupons in a personalized manner for users according to one or more user characteristic. Such user characteristic can include virtually anything related to the user or user profile including, geographic location, behavioral trends (including previous shopping record, previously visualized items, to average shopping cart value, historical stylistic preferences, historical brand preferences, historical shopping patterns, etc . . . ), size, employment, salary range, education, and even the characteristics of a related avatar. Thus the system can take advantage of knowledge obtained from a user's use of the graphical user interface to tailor coupons such that they are most effective. For example, if a user is shopping for a shirt and visualizes a particular shirt on an avatar more than once but doesn't purchase it, the system may provide the user with a coupon discount as incentive. Alternatively, a user that has often purchased at a particular store may be sent “good customer discounts” via coupons.

Advantageously, this coupon distribution scheme, particularly when the code is unique, permits an unprecedented tracking of cross-channel (web-to-store) coupon usage such that the effectiveness of various campaigns, marketing techniques and business strategies can be analyzed with increased detail and improved accuracy.

It should be noted that it is not necessary for the coupon to have originally applied to an online purchase. Indeed the system may be tailored for the purposes of browsing an inventory of goods or services and may even lack the provisions for completing a sale.

Although various embodiments have been illustrated, this was for the purpose of describing, but not limiting, the invention. Various modifications will become apparent to those skilled in the art and are within the scope of this invention, which is defined more particularly by the attached claims.

1. A method for facilitating the selection of purchasable items comprising:
a. allowing the user to select a key image from among a dictionary of key images, the key image being representative of a particular type of purchasable item;
b. identifying in at least one database of purchasable items at least one purchasable item of the particular type; and
c. causing the conveyance of an identification of the at least one purchasable to item of the particular type to the user.
